(19) United States
(12) Patent Application Publication
(10) Pub. No.: US 2023/0254179 A1
(43) Pub. Date: Aug. 10, 2023

(54) SYSTEM AND METHOD FOR STORING APPLIANCE DIAGNOSTICS DATA

(71) Applicant: Haier US Appliance Solutions, Inc., Wilmington, DE (US)

(72) Inventors: Leo Edward Hodapp, JR., Greenville, IN (US); Brian Timberlake, Jeffersonville, IN (US)

(21) Appl. No.: 17/665,012

(22) Filed: Feb. 4, 2022

(51) Int. Cl. H04L 12/28

(52) U.S. Cl. CPC H04L 12/2834; H04L 12/2809; H04L 12/281; H04L 12/2827; H04L 12/2836

(57) ABSTRACT

A method for recording data in an appliance includes identifying a data storage condition that corresponds to a particular data storage capacity or protocol. Based on the identification of the data storage condition, a data storage protocol may be determined, which includes at least one of a cycle count for which prior operating cycle data is stored in the system memory and a data density of the diagnostics data stored in the system memory (e.g., such as the recorded parameters or a sample rate of such parameters), and obtaining and storing diagnostics data in the system memory of the controller in accordance with the data storage protocol.

### FIELD OF THE INVENTION

The present subject matter relates generally to consumer or commercial appliances, such as domestic appliances, and more particularly to methods of storing diagnostics data in such appliances.

### BACKGROUND OF THE INVENTION

Conventional residential or commercial appliances collect and store data during operation that can later be used for diagnostic or other purposes. This data is normally collected on a cycle-by-cycle basis and includes various system parameters depending on the type of appliance. For example, a dishwasher may collect data related to water temperature, water level, sensors states, fault conditions, etc. This data may be useful for a number of purposes, e.g., including service diagnostics, consumer use analysis, etc.

However, onboard appliance controllers commonly include limited memory storage. Accordingly, as monitored parameters increase and the need to store more data increases, the problem arises where the onboard storage capacity of the unit becomes a limiting factor. In addition, conventional appliances store data based on predetermined protocols that are independent of the appliance status, accessing party, etc. For example, one user might be a service technician that needs a deep number of cycle records to determine the root cause of system faults during a service call. Another data consumer might be a data analyst focusing on feature selections in an attempt to understand user habits, and such a user may wish to retrieve as many data points as possible per cycle.

Accordingly, improved systems and methods for diagnosing fault conditions or monitoring appliance performance are desired. More specifically, systems and methods for improving the storage of diagnostics data would be particularly advantageous.

### BRIEF DESCRIPTION OF THE INVENTION

Aspects and advantages of the invention will be set forth in part in the following description, or may be obvious from the description, or may be learned through practice of the invention.

In one exemplary embodiment, a method for recording data in an appliance is provided. The appliance includes a controller comprising system memory. The method includes identifying a data storage condition, determining, based on the identified data storage condition, a data storage protocol, and obtaining and storing diagnostics data in the system memory of the controller in accordance with the data storage protocol.

In another exemplary embodiment, an appliance is provided including a system memory storing executable instructions and being configured to store diagnostics data related to operating cycles of the appliance and a processor communicatively coupled to the system memory and configured to execute the instructions to: identify a data storage condition; determine, based on the identified data storage condition, a data storage protocol selected from a plurality of protocols; and obtain and store diagnostics data in the system memory in accordance with the data storage protocol.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic view of a system of appliances according to exemplary embodiments of the present disclosure.

FIG. 2 provides a method for dynamically allocating memory in an appliance according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

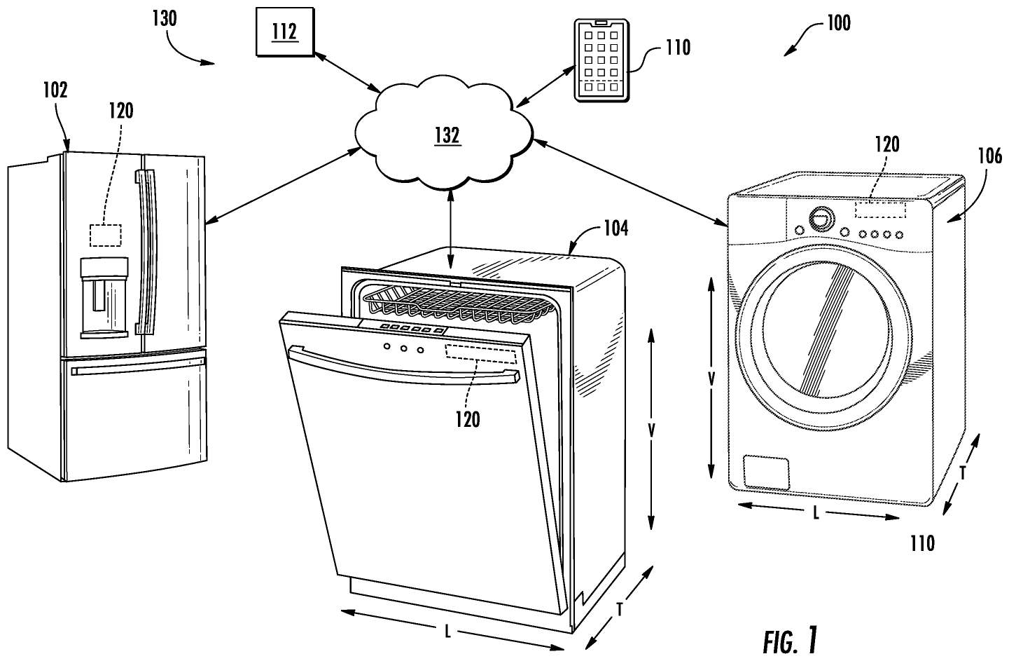

Referring now to FIG. 1, a system of appliances 100 will be described according to exemplary embodiments of the present subject matter. In general, system of appliances 100 may include any suitable number, type, and configuration of appliances, remote servers, network devices, and/or other external devices. Some of these appliances 100 may be able to communicate with each other or are otherwise interconnected. This interconnection, interlinking, and interoperability of multiple appliances and/or devices may commonly be referred to as “smart home” or “connected home” appliance interconnectivity.

FIG. 1 illustrates system of appliances 100 according to exemplary embodiments of the present subject matter. As shown, system of appliances 100 generally includes a first appliance 102 (e.g., illustrated herein as a refrigerator appliance), a second appliance 104 (e.g., illustrated herein as a dishwasher), and a third appliance 106 (e.g., illustrated herein as a washing machine). Details regarding the operation of first appliance 102, second appliance 104, and third appliance 106 may be understood by one having ordinary skill in the art and detailed discussion is omitted herein for brevity. However, it should be appreciated that the specific appliance types and configurations are only exemplary and are provided to facilitate discussion regarding the use and operation of an exemplary system of appliances 100. The scope of the present subject matter is not limited to the number, type, and configurations of appliances set forth herein.

For example, the system of appliances 100 may include any suitable number and type of “appliances,” such as “household appliances.” These terms are used herein to describe appliances typically used or intended for common domestic tasks, e.g., such as the appliances as illustrated in the figures. According to still other embodiments, these “appliances” may include but are not limited to a refrigerator, a dishwasher, a microwave oven, a cooktop, an oven, a washing machine, a dryer, a water heater, a water filter or purifier, an air conditioner, a space heater, and any other household appliance which performs similar functions. Moreover, although only three appliances are illustrated, various embodiments of the present subject matter may also include another number of appliances, each of which may generate and store data.

In addition, it should be appreciated that system of appliances 100 may include one or more external devices, e.g., devices that are separate from or external to the one or more appliances, and which may be configured for facilitating communications with various appliances or other devices. For example, according to exemplary embodiments of the present subject matter, the system of appliances 100 may include or be communicatively coupled with a remote user interface device 110 that may be configured to enable user interaction with some or all appliances or other devices in the system of appliances 100.

In general, remote user interface device 110 may be any suitable device separate and apart from appliances (e.g., such as first appliance 102, second appliance 104, and third appliance 106) that is configured to provide and/or receive communications, information, data, or commands from a user. In this regard, remote user interface device 110 may be an additional user interface to the user interface panels of the various appliances within the system of appliances 100. In this regard, for example, the user interface device 110 may be a personal phone, a smartphone, a tablet, a laptop or personal computer, a wearable device, a smart home system, or another mobile or remote device. For example, the separate device may be a smartphone operable to store and run applications, also known as “apps,” and the remote user interface device 110 be provided as a smartphone app.

In addition, as will be described in more detail below, some or all of the system of appliances 100 may include or be communicatively coupled with a remote server 112 that may be in operative communication with remote user interface device 110 and/or some or all appliances within system of appliances 100. Thus, user interface device 110 and/or remote server 112 may refer to one or more devices that are not considered household appliances as used herein. In addition, devices such as a personal computer, router, network devices, and other similar devices whose primary functions are network communication and/or data processing are not considered household appliances as used herein.

As illustrated, each of first appliance 102, second appliance 104, third appliance 106, remote user interface device 110, or any other devices or appliances in system of appliances 100 may include or be operably coupled to a controller, identified herein generally by reference numeral 120. As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of an appliance. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120. The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases and/or may be split up so that the data is stored in multiple locations. In addition, or alternatively, the one or more database(s) can be connected to controller 120 through any suitable communication module, communication lines, or network(s).

Referring still to FIG. 1, a schematic diagram of an external communication system 130 will be described according to an exemplary embodiment of the present subject matter. In general, external communication system 130 is configured for permitting interaction, data transfer, and other communications between and among first appliance 102, second appliance 104, third appliance 106, remote user interface device 110, remote server 112, other appliances within system of appliances 100, and/or one or more external devices. For example, this communication may be used to provide and receive operating parameters, cycle settings, user instructions or notifications, performance characteristics, user preferences, or any other suitable information for improved performance of one or more appliances within system of appliances 100. In addition, it should be appreciated that external communication system 130 may be used to transfer data or other information to improve performance of one or more external devices or appliances and/or improve user interaction with such devices.

In addition, remote server 112 may be in communication with an appliance and/or remote user interface device 110 through a network 132. In this regard, for example, remote server 112 may be a cloud-based server 112, and is thus located at a distant location, such as in a separate state, country, etc. According to an exemplary embodiment, remote user interface device 110 may communicate with a remote server 112 over network 132, such as the Internet, to transmit/receive data or information, provide user inputs, receive user notifications or instructions, interact with or control the appliance, etc. In addition, remote user interface device 110 and remote server 112 may communicate with the appliance to communicate similar information.

In general, communication between an appliance, remote user interface device 110, remote server 112, and/or other user devices or appliances may be carried using any type of wired or wireless connection and using any suitable type of communication network, non-limiting examples of which are provided below. For example, remote user interface device 110 may be in direct or indirect communication with the appliance through any suitable wired or wireless communication connections or interfaces, such as network 132. For example, network 132 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 130 is described herein according to an exemplary embodiment of the present subject matter. However, it should be appreciated that the exemplary functions and configurations of external communication system 130 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Now that the construction of system of appliances 100 and external communication system 130 have been presented according to exemplary embodiments, an exemplary method 200 of operating a system of appliances will be described. Although the discussion below refers to the exemplary method 200 of operating an appliance from system of appliances 100, one skilled in the art will appreciate that the exemplary method 200 is applicable to the memory usage and/or data allocation of any suitable number, type, and configuration of appliances. In exemplary embodiments, the various method steps as disclosed herein may be performed by one or more controllers (e.g., such as controllers 120) or by a separate, dedicated controller that may be located locally on one or more of the appliances, remotely on a remote server, etc.

Notably, as explained briefly above, consumer and commercial appliances commonly generate large amounts of data during normal operation. This data, referred to herein generally as “diagnostics data,” may be used for a variety of purposes by the user of the appliance or a third-party (e.g., such as the manufacturer). For example, this data may be used for diagnostic analysis, fault detection, root cause analysis, analysis of consumer use habits, or for any other suitable purpose generally intended for improving appliance performance and user satisfaction.

Notably, the receipt and storage of such large volumes of data may be expensive and the onboard storage capacity of conventional appliances may become a limiting factor in data storage, particularly as appliances become more complex and the need for more data increases. In this regard, as described briefly above, each appliance controller (e.g., controllers 120) may have a limited amount of system memory that is capable of storing diagnostics data.

Moreover, the type of diagnostics data that is desirable is largely dependent on the end user of such data. For example, a service technician who is troubleshooting an appliance fault may desire a large number of cycle records or a long history of appliance operation but may require relatively few recorded parameters in order to determine the root cause of such faults during a maintenance visit or service call. By contrast, a data analyst focusing on user routines or habits from a remote location, may not require as many cycle records to be saved by the machine since the data is streamed and stored in a remote server. Other users may desire an entirely different combination of data for their purposes. The situations result in a conflict between desirable diagnostics data that is stored and the available system resources. Accordingly, aspects of the present subject matter are directed to methods for improved storage of diagnostics data in an appliance, e.g., using dynamically allocated memory based on the use case or other factors.

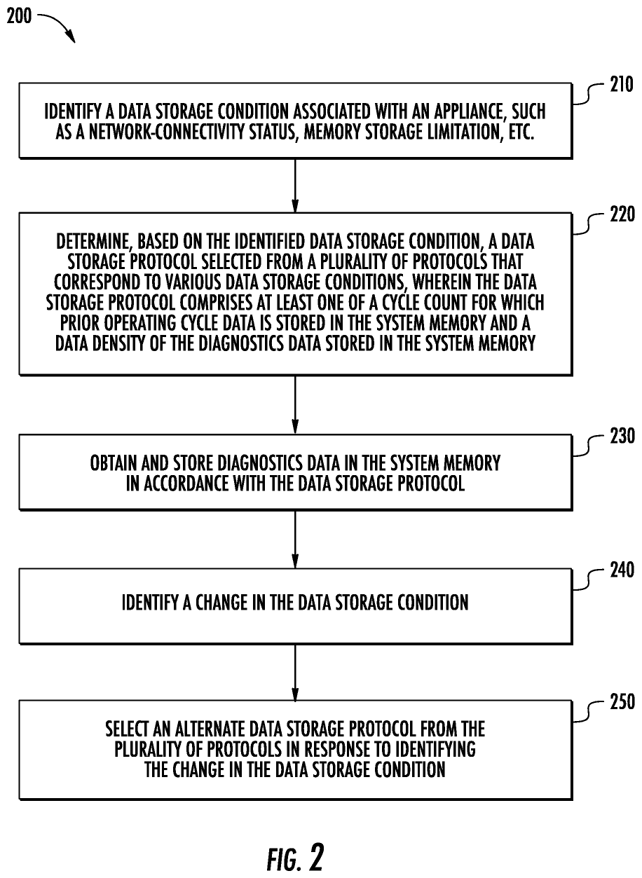

Specifically, referring now to FIG. 2, method 200 may include, at step 210, identifying a data storage condition associated with an appliance. As used herein, the terms “data storage condition” and the like are generally intended to refer to any appliance condition or external stimulus that is detectable by an appliance and which may be indicative of a need to adjust the memory allocation or storage configuration of the appliance. Although exemplary data storage conditions are described herein to facilitate discussion of aspects of the present subject matter, it should be appreciated that other data storage conditions are possible and within scope the present subject matter.

For example, the data storage condition may relate to the network connectivity status of an appliance, to an available system memory or memory storage limitation, etc. In this regard, for example, identifying the data storage condition may include determining that the appliance is connected to a network. In this regard, for example, if the first appliance 102 is connected to network 132 and/or remote server 112, first appliance 102 may transmit diagnostics data to remote server 112 for remote storage and analysis. Accordingly, system memory limitations may be less critical and more data may be obtained without the risk of running out of system memory. By contrast, if the first appliance 102 is not connected to a network, e.g., such that all diagnostics data is stored locally on the system memory of controller 120, it may be desirable to record a different number of parameters at a different sampling rate and for a different number of operating cycles (e.g., or less historical data related to appliance operation).

Step 220 may generally include determining, based on the data storage condition (e.g., identified at step 210), a data storage protocol that corresponds to the data storage condition. As used herein, the terms “data storage protocol” and the like are generally intended to refer to the system instructions or rules regarding what diagnostics data is obtained, at what frequency, for how many cycles, etc. According to exemplary embodiments, controllers 120 may store a plurality of protocols that each correspond to various data storage conditions. For example, as explained briefly above, if the appliance is not connected to a network and the end user of data is a data analyst, the first data storage protocol may be selected. By contrast, if the client is connected to a network and the end-user is a maintenance technician, another data storage protocol may be preferred.

According to exemplary embodiments, the data storage protocol may include at least one of a cycle count for which prior operating cycle data is stored in the system memory and a data density of the diagnostics data that is stored in system memory for each operating cycle. Although the data storage protocols are described herein as being related at least in part to an “operating cycle” of an appliance, it should be appreciated that this term is generally intended to refer to the operating history or duration of time that data is recorded. For example, the cycle count for a dishwasher may refer to the number of times a complete dishwashing cycle has been performed, whereas a cycle count for a refrigerator appliance may refer to the number of hours that the appliance is been running, to the number of compressor cycles or sealed system operating cycles performed, etc.

In general, the terms “data density” and the like are generally intended to refer to the amount or size of data recorded during an operating cycle of an appliance or during operation of an appliance over a particular time period. This data density may include, for example, both the number of recorded cycle parameters and a sample rate or frequency at which those recorded cycle parameters are recorded. For example, recorded cycle parameters for a dishwasher may include water level measurements, turbidity measurements, water temperature measurements, fault conditions, sensor states, etc. The sample rate or frequency may refer to how often each of these recorded parameters are recorded as diagnostics data in system memory. Notably, the data densities as described herein are only exemplary and are not intended to limit the scope of the present subject matter in any manner. Moreover, it should be appreciated that the data density recorded by appliances 102-106 may be adjusted or manipulated in any suitable manner.

Once the data storage protocol is determined, step 230 may include obtaining and storing diagnostics data in the system memory in accordance with the data storage protocol. For example, if the data storage condition is that an appliance is not connected to a network, the data storage protocol associated with that condition may include storing diagnostics data for an increased cycle count and at a lowered data density. For example, this lowered data density may be decreased relative to a standard predetermined data density or may otherwise be lower than other data storage protocols, such as a network-connected data storage protocol. For example, if the standard protocol calls for storing historical data related to the last five operating cycles, the non-networked data storage protocol may include increasing the cycle count to 10 operating cycles, 20 operating cycles, or more operating cycles. In addition, or alternatively, the lowered data density may be achieved by obtaining fewer recorded parameters and/or obtaining such parameters at lower sampling rates. According to exemplary embodiments, if the data storage condition indicates that the system memory has fallen below a predetermined memory threshold, the data storage protocol may be the same or similar to the non-networked data storage protocol.

By contrast, if the data storage condition is that an appliance is connected to a network, the data storage protocol associated with that condition may include storing diagnostics data for a lowered cycle count and at an increased data density. In this regard, because diagnostics data may be stored remotely, the system memory may be used to obtain richer data for each cycle, and that data maybe offloaded to a remote server 112. For example, this increased data density may be increased relative to a standard predetermined data density or may otherwise be higher than other data storage protocols, such as a non-networked data storage protocol. For example, if the standard protocol calls for storing historical data related to the last five operating cycles, the network-connected data storage protocol may include lowering the cycle count to three operating cycles, two operating cycles, or a single operating cycle. In addition, or alternatively, the increased data density may be achieved by obtaining more recorded parameters and/or obtaining such parameters at higher sampling rates. It should be appreciated that the data storage protocols to be manipulated by the user, manufacturer of the appliance, or maintenance technician such that the desired data is obtained and stored for each operating condition and end-user.

Referring again to FIG. 2, step 240 may generally include identifying a change in the data storage condition. In this regard, throughout operation of each appliance 102-106, the data storage condition may vary. For example, data storage condition may change upon receiving a command from a maintenance technician or a user, e.g., requesting that a different data storage protocol be used. In addition, or alternatively, if there is a network disruption or a previously non-networked appliance is connected to the network, this may result in a change in the data storage condition.

Step 250 includes selecting an alternate data storage protocol from the plurality of protocols in response to identifying the change in the data storage condition. In this manner, each appliance 102-106 may dynamically allocate memory storage based on existing conditions related to available memory, the end-user of the diagnostics data, and real-time conditions related to appliance usage. In this manner, targeted diagnostic data may be delivered to the end-user of such data while optimizing memory storage for each particular appliance.

FIG. 2 depicts an exemplary control method having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of these methods are explained using appliances 102-106 and remote server 112 as an example, it should be appreciated that these methods may be applied to the operation of any suitable appliance or system of appliances.

As explained above, aspects of the present subject matter are generally directed to a system and method for reconfiguring diagnostics data memory on a household appliance. For example, the method may include determining a grouping of data that is to be stored based on an end use case of a consumer. The groupings of data may be organized into a minimum of two groupings and data may be organized by providing cycle depth information but with a minimum of per cycle data and other by providing a breadth of cycle data but fewer overall records.

A dynamically allocated memory for diagnostic data storage is programmable to accommodate specific use cases for various consumers of the data. For the deep cycle data, storage is programmed to accommodate specific use cases for various consumers of the data in n×m that is equal to the total number of locations, where n is the number of cycle records and m is the number of data points for a given number of data memory elements. This configuration may be programmed during manufacturing and the deep cycle data storage history is beneficial to understand the operation and faults of the machine during service.

The machine can be connected to a cloud server to enable data streaming back to the server when the machine is installed in the consumer's home. The cloud server has significantly more storage than the machine, so the diagnostic data memory may be reprogrammed to take advantage of the connection. For example, the number of data points collected per cycle increases by an arbitrary amount, whereas the number of cycle records decreases by the same count, and the overall data storage elements remain the same.

The memory can be reprogrammed using a service tool carried by service technicians, who may gather additional data on a per cycle basis and come back at a later service date to analyze the data. The methods described herein deliver targeted diagnostic data for a particular use case but optimized for available system memory resources thus saving overall costs.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method for recording data in an appliance, the appliance comprising a plurality of diagnostics data sources and a controller comprising system memory, the method comprising:
identifying a data storage condition;
determining, based on the identified data storage condition, a data storage protocol, the data storage protocol comprising, for each of the plurality of diagnostics data sources, local system instructions for whether diagnostics data is obtained, at what frequency, and for how many appliance operating cycles; and
obtaining and storing diagnostics data in the system memory of the controller in accordance with the data storage protocol.

2. The method of claim 1, wherein the data storage protocol comprises at least one of a cycle count for which prior operating cycle data is stored in the system memory and a data density of the diagnostics data stored in the system memory.

3. The method of claim 2, wherein the data density comprises at least one of a number of recorded cycle parameters and a sample rate of the recorded cycle parameters.

4. The method of claim 1, wherein identifying the data storage condition comprises:
determining that the appliance is not connected to a network, wherein the data storage protocol comprises storing the diagnostics data for an increased cycle count and at a lowered data density.

5. The method of claim 4, wherein the increased cycle count is twenty operating cycles.

6. The method of claim 1, wherein identifying the data storage condition comprises:
determining that the appliance is connected to a network, wherein the data storage protocol comprises storing the diagnostics data for a lowered cycle count and at an increased data density.

7. The method of claim 6, wherein the lowered cycle count is five operating cycles.

8. The method of claim 1, wherein identifying the data storage condition comprises:
determining that a storage capacity of the system memory falls below a predetermined memory threshold, wherein the data storage protocol comprises storing the diagnostics data for an increased cycle count and at a lowered data density.

9. The method of claim 1, further comprising:
identifying a change in the data storage condition; and
adjusting the data storage protocol in response to identifying the change in the data storage condition.

10. The method of claim 9, wherein identifying the change in the data storage condition comprises:
receiving a command from a maintenance technician or a user, determining that the appliance has been connected or disconnected from a network, or determining that the system memory falls below a predetermined memory threshold.

11. The method of claim 1, wherein the data storage condition and the data storage protocol corresponding to the data storage condition are programmable by a user, a manufacturer, or a maintenance technician.

12. An appliance comprising:
a plurality of diagnostics data sources located within the appliance, each of the plurality of diagnostics data source being configured to generate diagnostics data during appliance operation;
a system memory storing executable instructions and being configured to store diagnostics data related to operating cycles of the appliance; and
a processor communicatively coupled to the system memory and configured to execute the instructions to:
identify a data storage condition;
determine, based on the identified data storage condition, a data storage protocol selected from a plurality of protocols, the data storage protocol comprising, for each of the plurality of diagnostics data sources, local system instructions for whether the diagnostics data is obtained, at what frequency, and for how many appliance operating cycles; and
obtain and store diagnostics data in the system memory in accordance with the data storage protocol.

13. The appliance of claim 12, wherein the data storage protocol comprises at least one of a cycle count for which prior operating cycle data is stored in the system memory and a data density of the diagnostics data stored in the system memory.

14. The appliance of claim 13, wherein the data density comprises at least one of a number of recorded cycle parameters and a sample rate of the recorded cycle parameters.

15. The appliance of claim 12, wherein identifying the data storage condition comprises:
determining that the appliance is not connected to a network, wherein the data storage protocol comprises storing the diagnostics data for an increased cycle count and at a lowered data density.

16. The appliance of claim 12, wherein identifying the data storage condition comprises:
determining that the appliance is connected to a network, wherein the data storage protocol comprises storing the diagnostics data for a lowered cycle count and at an increased data density.

17. The appliance of claim 12, wherein identifying the data storage condition comprises:
determining that a storage capacity of the system memory falls below a predetermined memory threshold, wherein the data storage protocol comprises storing the diagnostics data for an increased cycle count and at a lowered data density.

18. The appliance of claim 12, wherein the processor is further configured to:
identify a change in the data storage condition; and
select an alternate data storage protocol from the plurality of protocols in response to identifying the change in the data storage condition.

19. The appliance of claim 18, wherein identifying the change in the data storage condition comprises:
receiving a command from a maintenance technician or a user, determining that the appliance has been connected or disconnected from a network, or determining that the system memory falls below a predetermined memory threshold.

20. The appliance of claim 12, wherein the data storage condition and the plurality of protocols are programmable by a user, a manufacturer, or a maintenance technician.
